(19) United States
(12) Patent Application Publication
(10) Pub. No.: US 2014/0149325 A1
(43) Pub. Date: May 29, 2014

(54) SYSTEM MONITOR AND METHOD OF SYSTEM MONITORING

(71) Applicant: ISIS INNOVATION LIMITED, Oxford, Oxfordshire (GB)

(72) Inventors: David Andrew Clifton, Oxford (GB); Samuel Yung Hugueny, Oxford (GB); Lionel Tarassenko, Oxford (GB)

(73) Assignee: ISIS INNOVATION LIMITED, Oxford, Oxfordshire (GB)

(21) Appl. No.: 14/122,060

(22) PCT Filed: May 16, 2012
(86) PCT No.: PCT/GB2012/051092

§ 371 Date: Jan. 30, 2014

(30) Foreign Application Priority Data
May 24, 2011 (GB) 1108778.0

(51) Int. Cl. G06N 7/00; G06N 99/00

(52) U.S. Cl. CPC G06N 7/005; G06N 99/005
USPC 706/12; 706/52

(57) ABSTRACT

A method of system monitoring or, more particularly, novelty detection, based on extreme value theory in particular a points-over-threshold POT method which is applicable to multimodal multivariate data. Multimodal multivariate data points collected by continuously monitoring a system are transformed into probability space by obtaining their probability density function (pdf) values from a statistical model of normality, such as a pdf fitted to a training data set of normal data. Extremal data is defined as that whose pdf value is below a predetermined threshold and a new analytic function, in particular the Generalised Pareto Distribution (GPD) is fitted to that extremal data only. The fitted GPD can be compared to a GPD fitted to the extremal datapoints of the training data set of normal data to determine if the monitored system is in a normal state. Alternatively a threshold can be set by calculating an extreme value distribution of the GPD fitted to the extremal data of the training data set and setting as the threshold the pdf value which separates a desired proportion, e.g., 0.99 of the probability mass from the remainder. If the minimum pdf value of a set of data points collected from the system is below the threshold, the system may be abnormal.

The present invention relates to the field of systems monitoring and in particular to the automated, continuous analysis of the condition of a system.

Systems monitoring is applicable to fields as diverse as the monitoring of machines, or the monitoring of human patient's vital signs in the medical field, and typically such monitoring is conducted by measuring the state of the system using a plurality of sensors each measuring some different parameter or variable of the system. To assist in the interpretation of the multiple signals acquired from complex systems, developments over the last few decades have led to automated analysis of the signals with a view to issuing an alarm to a human user or operator if the state of the system departs from normality. A basic and traditional approach to this has been to apply a threshold to each of the individual sensor signals, with the alarm being triggered if any, or a combination of, these single-channel thresholds is breached. However, it is often difficult to set such thresholds automatically at a point which on the one hand provides a sufficiently safe margin by alarming reliably when the system departs from normality, but on the other hand does not generate too many false alarms, which leads to alarms being ignored. Further, such single-channel thresholds do not allow for situations where the system is in an abnormal state as indicated by an abnormal combination of signals from the sensors even though each individual signal is within its individual single-channel threshold.

Consequently more recently techniques have been developed which assess the state of a system relative to a model of normal system condition, with a view to classifying data from the sensors as normal or abnormal with respect to the model. Such novelty detection, or 1-class classification, is particularly well-suited to problems in which a large quantity of examples of normal behaviour exist, such that a model of normality may be constructed, but where examples of abnormal behaviour are rare, such that a traditional multi-class approach cannot be taken. Novelty detection is therefore useful in the analysis of data from safety-critical systems such as jet engines, manufacturing processes, or power-generation facilities, which spend the majority of their operational life in a normal state, and which exhibit few, if any, failure conditions. It is also applicable in the medical field, where human vital signs are treated in the same way.

As indicated above, novelty detection is performed with respect to a model of normality for the system. Such a model can typically be produced by taking a set of measurements of the system while it is assumed or assessed (e.g. by an expert—such as a doctor in the medical scenario) to be in a normal state (these measurements then being known as the training set) and fitting some analytical function to the distribution of the data. For example, for multivariate and multimodal data the function could be a Gaussian Mixture Model (GMM), Parzen Window Estimator, or other mixture of kernel functions. In this context, multivariate means that there are a plurality of variables—for example each variable corresponds to a measurement obtained from a single sensor or some single parameter of the system and multimodal means that the function has more than one mode (i.e. more than one local maximum in the probability distribution function that describes the distribution of values in the training set). The model of normality can therefore be represented as a probability density function y(x) (the GMM or other function fitted to the training set) over a multidimensional space with each dimension corresponding to an individual variable or parameter of the system.

Having constructed such a model of normality one approach to novelty detection is simply to set a novelty threshold on the probability density function (pdf) such that a data point x is classified as abnormal if the probability density function value y(x) is less than the threshold. Such thresholds are simply set so that the separation between normal and any abnormal data is maximised on a large validation data set, containing examples of both normal and abnormal data labelled by system domain experts. Such an approach is described in WO-A2-02096282 where the threshold is a novelty index representing the distance in the multiparameter measurement space from normality. A similar alternative approach is to consider the cumulative probability function P(x) associated with the probability distribution: that is to find the probability mass P obtained by integrating the probability density function y(x) up to the novelty threshold and to set the threshold at that probability density which results in the desired integral value P (for example so that 99% of the data is classified normal with respect to the threshold). This allows a probabilistic interpretation, namely: if one were to draw a single sample from the model, it would be expected to lie outside the novelty threshold with a probability 1-P. For example, if the threshold were set such that P is 0.99, so that 99% of single samples could be expected to be classified normal, then 1-P is 0.01, and 1% of single samples would expected to be classified abnormal with respect to that threshold. However, these approaches encounter the problem that although the probabilistic interpretation is valid for consideration of a single sample taken from the model, if multiple samples are taken from the model, as occurs in the continuous monitoring of real-life systems, the probability that the novelty threshold will be exceeded increases, and is no longer given by 1-P. Thus while the technique above is valid for applications where one is comparing a single measurement to a model of normality (for example comparing a single mammogram to a model constructed using “normal” mammogram data) it is not valid for applications where systems are being continually monitored with sensor measurements being sampled on a continual basis generating a continual stream of readings.

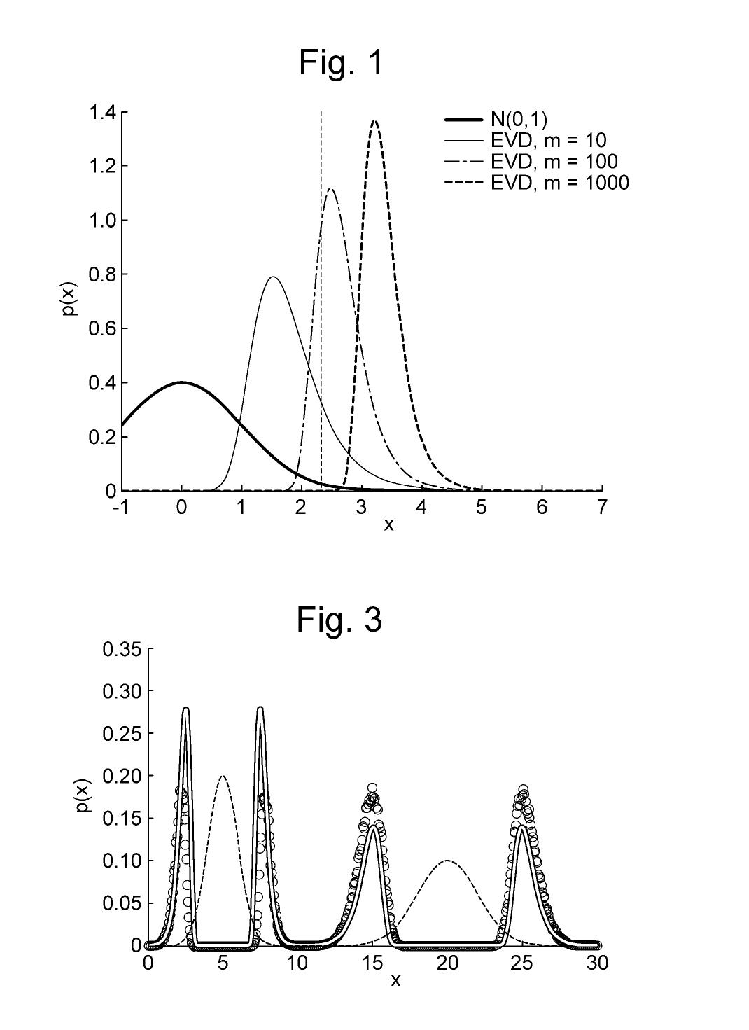

Because abnormal states of a system will generally be associated with extreme values of the variables being measured, interest has developed in using extreme value theory in the monitoring of systems. Extreme value theory is a branch of statistics concerned with modelling the distribution of very large or very small values (extrema) within sets of data points with respect to the probability distribution function describing the location of the normal data. Extreme value theory allows the examination of the probability distribution of extrema in data sets drawn from a particular distribution. For example FIG. 1 of the accompanying drawings illustrates a Gaussian distribution labelled p(x) of one dimensional data x (i.e. a univariate unimodal distribution) in the solid line with corresponding extreme value distributions (EVD) for data sets having different numbers of samples m=10, 100, 1000. Thus the extreme value distribution gives the probability of each value of x appearing as an extremum of a set of m data points drawn randomly from the Gaussian distribution. The shape of the extreme value distribution can be understood by considering that points which are at the centre of the Gaussian distribution are very unlikely to appear as extrema of a data set, whereas points far from the centre (the mode) of the Gaussian are quite likely to be extrema if they appear in the data set, but they are not likely to appear very often. Thus as illustrated the form of the EVD is that it takes low values at the centre and edge of the Gaussian with a peak between those two areas. The particular shape of the curve for a Gaussian distribution of data is a Gumbel distribution.

FIG. 1 also illustrates the problem mentioned above of setting a threshold (dotted) on a particular data value. Although it can be seen that for data sets with small values (e.g. m=10) the peak of the EVD is below the threshold, which means that the most probable extreme values of such data sets (which, it should be recalled, are data from a system in its normal condition), are below the threshold, as the size of the data set increases the peak of the EVD moves to the right, above the threshold, so that for data sets of 100 or 1000 samples the most likely extreme values are beyond the threshold. This means that even though the system is normal, an extremum of a large data set is quite likely to trigger a false alarm by exceeding the threshold, and the situation gets worse as more readings are taken (i.e. as m increases).

Because of these problems, extreme value theory has been proposed for novelty detection in the engineering, health and finance fields. By examining the extreme value distribution it is possible to use it to classify data points as normal or abnormal. It is possible, for example, to set a threshold on the extreme value distribution, for example at 0.99 of the integrated Gumbel probability distribution, which can be interpreted as meaning that out of a set of actual measurements on the system, if the extremum of those measurements is outside the threshold, this has less than a 1% chance of being an extremum of a normal data set. Consequently, that measurement can be classified as abnormal. Obviously the threshold can be set as desired.

Although the use of extreme value theory correctly, therefore, focuses on the data that lie in the tail of the distribution and thus of are low probability and are likely to represent abnormality, existing approaches are based on the assumption that the data in the tail of the distribution can be accurately modelled by the same statistical model (pdf) as used for the rest of the distribution. However the statistical model tends inevitably to accurately model the distribution in the regions of high support by lots of data, but does not tend accurately to model regions with low data support, i.e. where data is sparse, which is exactly the situation in the tail of the distribution. This lower accuracy of modelling reduces the reliability of the monitoring and the reliability with which normal and abnormal states are distinguished.

Furthermore, it is always difficult to distinguish between abnormal states and extremal but normal states of a system. In other words, it has to be remembered that in a distribution representing normal states of the system, even the data points in the low probability tails of the distribution are also representative of normal states. This applies both where the model of normality is a population-based model, which would normally be previously-acquired data, or an individual-based model, which could be obtained by collecting data from, e.g. a patient, in real-time (an online learning mode). In the population-based case there will be individuals whose normal states are extremal with respect to the bulk of the population. In the individual-based case even an individual's normal condition will vary, and so sometimes they will be extremal but nevertheless still normal.

Most existing work on applying extreme value theory has been limited to unimodal univariate data for example as illustrated in FIG. 1 and, as mentioned above, for complex systems data is likely to be multivariate and may also be multimodal.

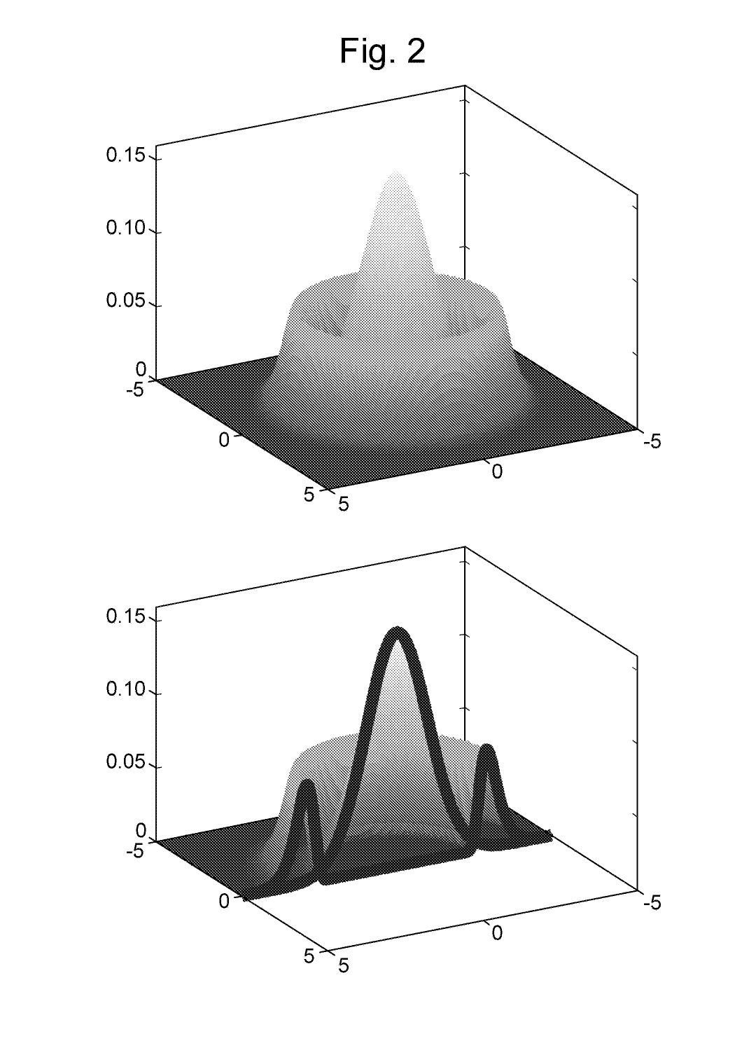

FIG. 2 illustrates a bivariate Gaussian distribution (the centre peak) together with its corresponding extreme value distribution (the surrounding torus). Although one might expect that the novelty detection techniques used in univariate extreme value theory could straightforwardly be extended to two dimensions as illustrated in FIG. 2, by using the radius from the mode as the univariate variable, in fact as the dimensionality of the data set increases, classical extreme value theory tends to introduce increasing error in its estimates of the EVD. Further, the approach has tended to rely on estimation of the dependence structure between extremes of the different variables which is difficult.

It should also be noted that the data in FIG. 2 is unimodal—i.e. there is a single peak in the probability distribution. The extension of extreme value theory to multimodal, for example bimodal, data is also problematic. FIG. 3 illustrates a bimodal generative probability density function (the dashed line) representing a model of normal data in a training data set, with the extreme value distribution predicted by existing methods (solid line). The bimodal distribution in FIG. 3 is a mixture of two Gaussian distributions and so the extreme value distribution is a Gumbel type distribution around each of the Gaussian modes or kernels. These extreme value distributions obtained by existing classical methods are generated on the assumption that the closest Gaussian kernel dominates the distribution of extreme values and thus the other kernel can be ignored. Also illustrated in FIG. 3, though, by the circles is a histogram for N=10⁶ experimentally-obtained extrema of data sets each including 100 data points. It can be seen that the fit between the experimentally obtained data (circles) and the predicted extreme value distribution (solid line) is poor.

In summary, therefore, although existing classical extreme value theory appears to offer the prospect of meaningful probabilistic interpretations of the thresholds for use in novelty detection, the extension of current techniques to the tails of multivariate and/or multimodal distributions has not been successful.

The present invention provides a way of extending extreme value theory to the tails of multimodal multivariate data to allow reliable novelty detection on such data.

Normally an extreme value of a data set is defined to be that which is either a minimum or maximum of the set in terms of absolute signal magnitude. For example in novelty detection, when considering the extrema of unimodal distributions as illustrated in FIGS. 1 and 2, the extrema are at the minimum or maximum distance from the single mode of the distribution. However for multimodal data there is no single mode from which distance may be defined. For example in FIG. 3 data midway between the two modes is clearly extremely unlikely, because this region has very low probability density with respect to the model, and thus represents an abnormal state for the system. However such data is not at an extreme value of x in terms of absolute magnitude, and so classical extreme value theory would not class data falling within this improbable region as being abnormal.

As a first step in the present invention the extremal values forming the tail of a distribution of data are redefined in terms of probability, given that the goal for novelty detection is to identify improbable events with respect to the normal state of the system, rather than events of extreme absolute magnitude. Thus in accordance with the present invention the tail of a distribution y(x), e.g. a probability density function (pdf), modelling a set of n samples x=x₁, x₂ . . . xₙ, is that part of the distribution whose pdf values are lower than a predetermined threshold. Thus the “extrema” are redefined as to be those observations that are extreme in probability space of Y rather than those that are extreme in the data space of X.

A second step in the invention is to select only those data points in the tail of the distribution (defined as extremal in probability space) and to fit a new distribution function to those selected data points. This avoids the problem that what is an appropriate model for the heavily-populated part of the distribution may not be an appropriate model for the relatively sparsely populated tail of the distribution. It is known that in a peaks over threshold (POT) method of extreme value theory, which considers exceedances over (or shortfalls under) some extremal threshold, with certain assumptions the distribution function of the exceedances—i.e. the tail data—tends towards a known form, the Generalised Pareto Distribution (hereafter GPD)

$${G}_{Y} ( y ) = 1 - {( 1 + ξ \frac{y - v}{β} )}^{\frac{- 1}{ξ}}$$

$$if$$

$$ξ \neq 0$$

$$1 - exp ( - \frac{y - v}{β} )$$

$$if$$

$$ξ = 0$$

where v, β and ξ are location, scale and shape parameters respectively whose values are set by fitting to the data y.

The inventors have found that the GPD is suitable for modelling the distribution of extremal values of the pdfs of multi-variate multi-modal data such as obtained in multi-parameter system monitoring.

1. An advantage of accurately and specifically modelling the tail of the distribution is that it then becomes possible to distinguish between extremal but normal states of the system and abnormal states of the system. In detail this can be achieved either by observing the form of the GPD fitted to the tail data or by calculating an extreme value distribution of the fitted GPD, using that extreme value distribution to set a threshold in probability space (i.e. a threshold y value) and comparing each data point collected from the system to that threshold. In more detail, therefore, the present invention provides a method of system monitoring to automatically detect abnormal states of a system, the method comprising the steps of: (a) repeatedly measuring a plurality of system parameters to produce multi-parameter data points each representing the state of the system at a particular time; (b) comparing each data point to a statistical model giving the probability density function of the normal states of the system to obtain a probability density function value for each data point; and (d) determining whether or not the system state is normal by comparing the obtained probability density function values to a threshold based on a distribution function fitted to those probability density function values of a set of data points known to represent low probability normal states of the system (i.e. the tail of the distribution).

Thus the invention allows a different model (distribution function) to be fitted to the tail data—and this is done in the univariate probability space not the multivariate data space, and the determination of normality/abnormality is done with respect to this different fitted distribution.

The step of determining whether or not the system state is normal from the fitted distribution function may comprise comparing the distribution of the obtained probability density function values (i.e. of the current data) to the fitted distribution function.

The step of determining whether or not the system state is normal from the fitted distribution function may comprise comparing a distribution function fitted to the obtained probability density function values (i.e. of the current data) with the distribution function fitted to those probability density function values of a set of data points known to represent low probability normal states of the system. These may be selected from a training data set of measurements on the system in a normal state as points which correspond to a probability density function value lower than the first predetermined threshold.

Alternatively, the step of determining whether or not the system state is normal from the fitted distribution function may comprise: calculating an extreme value distribution of a distribution function fitted in probability space to the tail data only of a training set of normal data, setting the threshold on the extreme value distribution as that pdf value which separates a selected proportion of the higher probability mass from the lower probability remainder, and comparing the probability density function value of said multi-parameter data points (i.e. the current data) from the system being monitored to the threshold. The extreme value distribution may be calculated by generating a plurality of sets of values from the fitted distribution function, selecting the extremum of each of said sets and fitting an analytic extreme value distribution to the selected extrema. The analytic extreme value distribution may be the Weibull distribution.

The distribution function may be the Generalised Pareto Distribution.

The statistical model may be multimodal and/or multivariate, each variable of the statistical model corresponding to one parameter of said multi-parameter data points, each parameter being a measurement of an output of a sensor on the system.

The invention also provides a system monitor for monitoring the state of a system in accordance with the method above, the monitor storing the statistical model and being adapted to perform said repeated measurements of the state of the system to execute said method to classify the system state as normal or abnormal. The system monitor may be adapted to acquire measurements of said system state continually and to execute said method on a rolling window of m successive measurements. It may be further adapted to store measurements of the system state classified as normal for use in retraining the statistical model.

The invention is applicable to patient monitoring in which case the “system” is a human patient and the measurements of system parameters comprise measurements of some vital signs, for example at least two of: heart rate, breathing rate, oxygen saturation, body temperature, systolic blood pressure and diastolic blood pressure.

The invention will be further described by way of example with reference to the accompanying drawings in which:

FIG. 1 illustrates a Gaussian PDF y(x) of data x together with the corresponding extreme value distribution (EVD) yₑ₍ₓ₎;

FIG. 2 illustrates a bivariate Gaussian distribution and corresponding EVD;

FIG. 3 illustrates a bimodal probability density function with classically predicted EVD and experimentally obtained EVD;

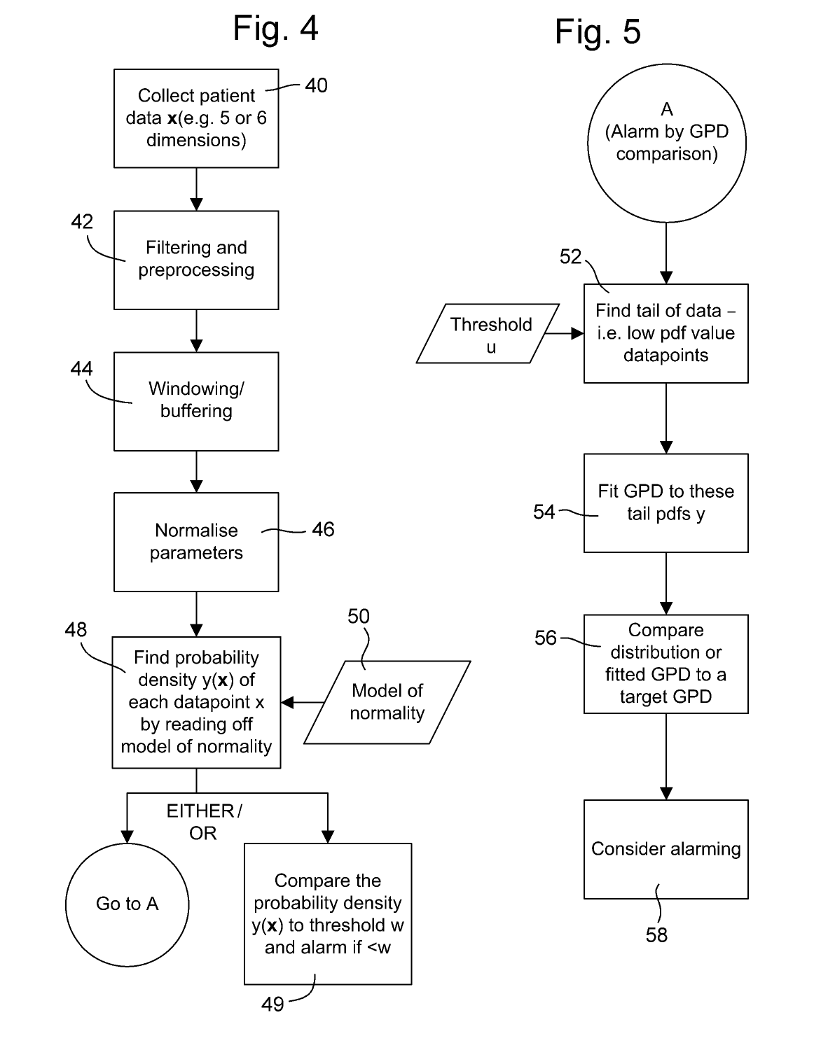

FIG. 4 is a flow chart schematically illustrating system monitoring in accordance with one embodiment of the invention;

FIG. 5 is a flow chart schematically illustrating one alarm method in accordance with an embodiment of the present invention;

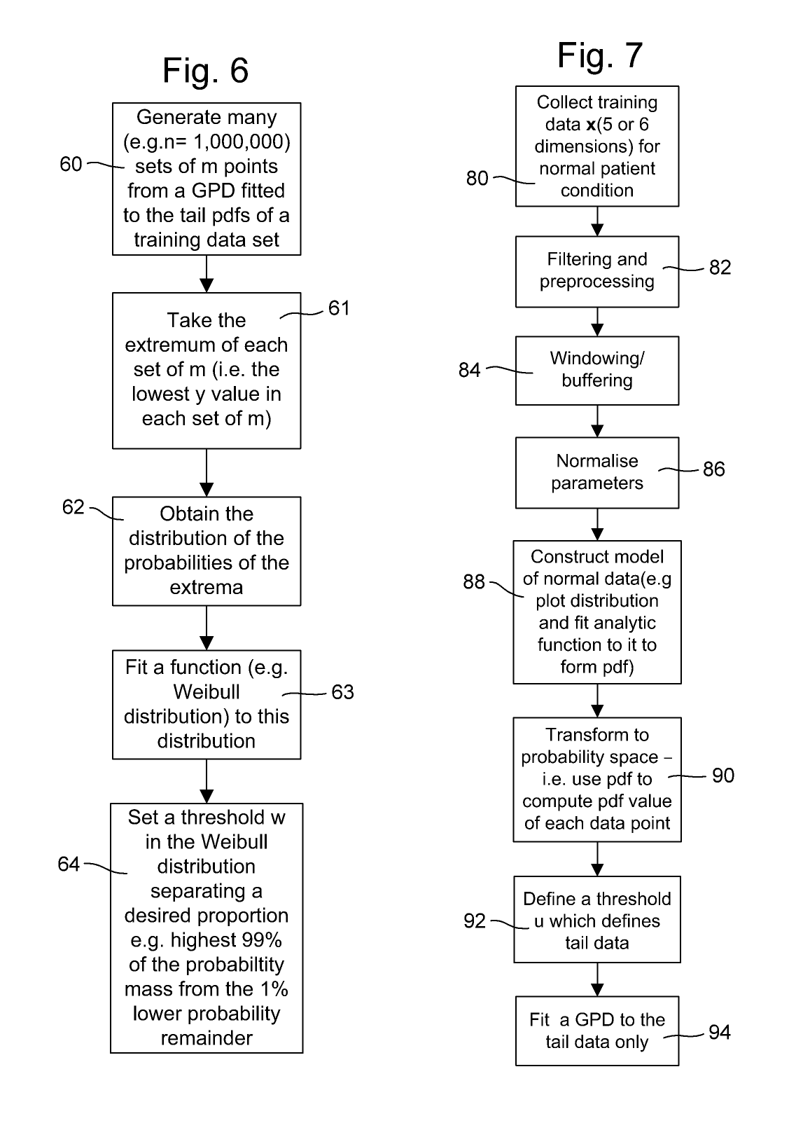

FIG. 6 is a flow chart schematically illustrating an alternative alarm method in accordance with an embodiment of the invention;

FIG. 7 is a flow chart schematically illustrating training of a statistical model of normality for use in an embodiment of the invention;

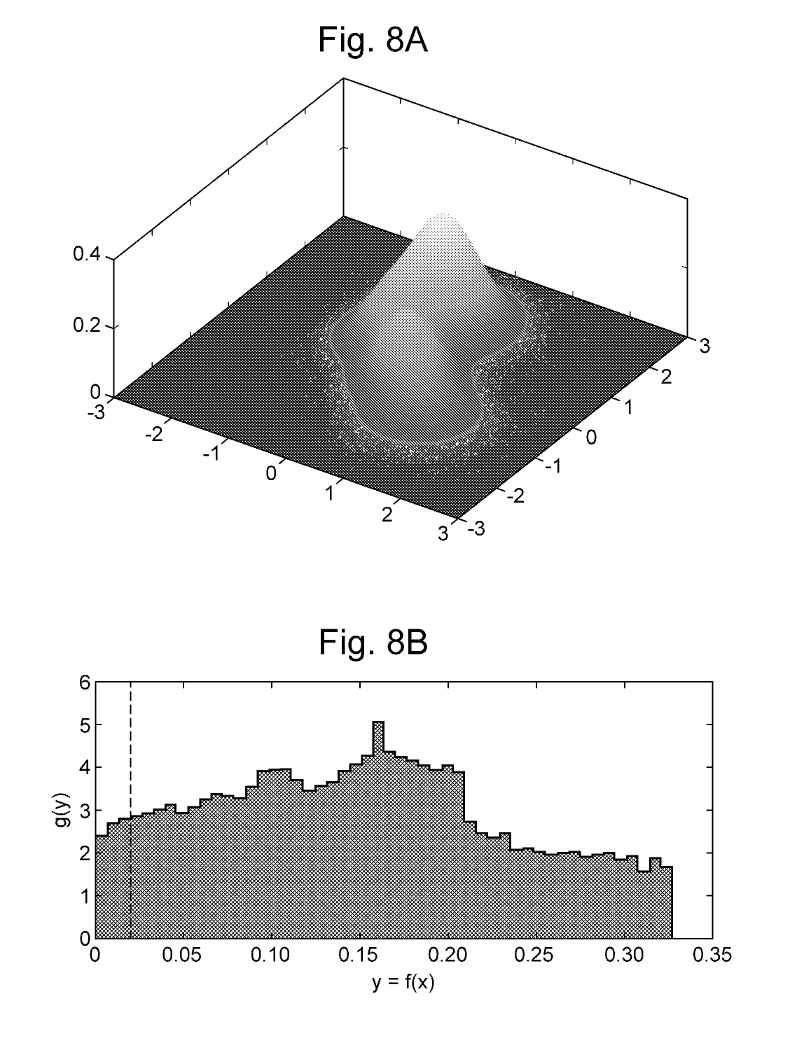

FIG. 8a illustrates an example bimodal bivariate distribution and FIG. 8b the corresponding distribution of probabilies;

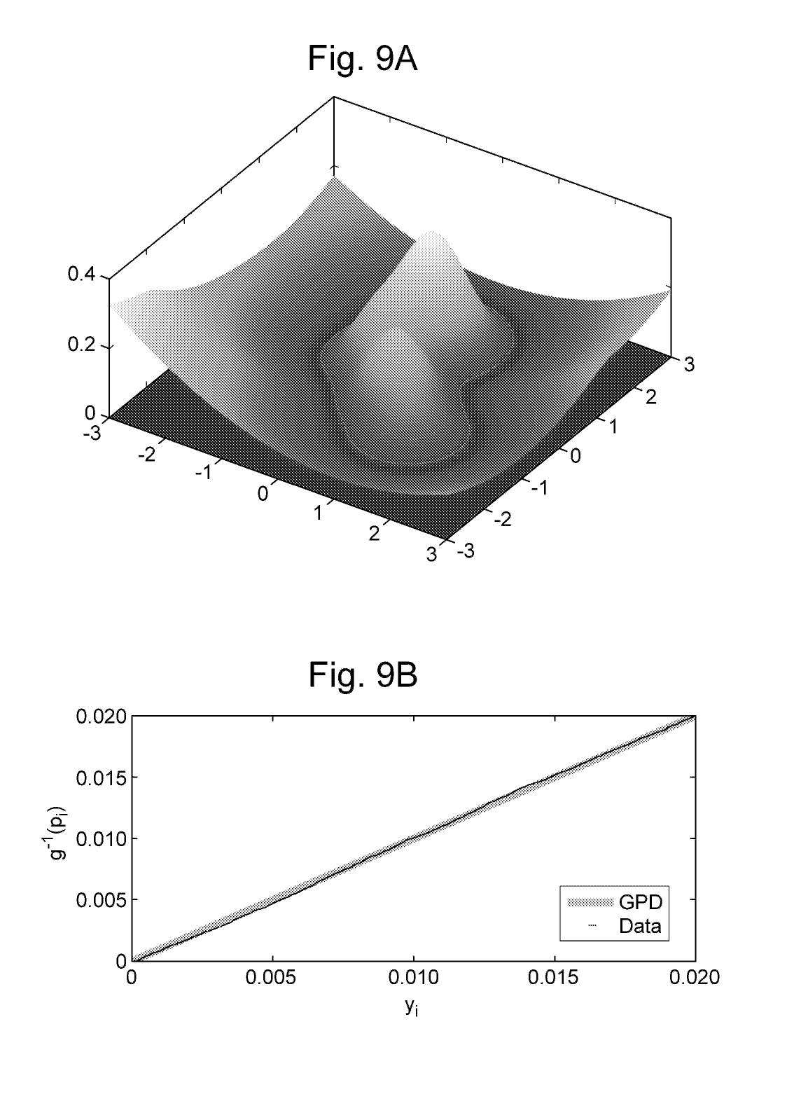

FIG. 9a illustrates a GPD fitted to the tail data of FIG. 8 mapped back into the data space and FIG. 9b illustrates a quantile-quantile (QQ) plot comparing the data and the fitted GPD;

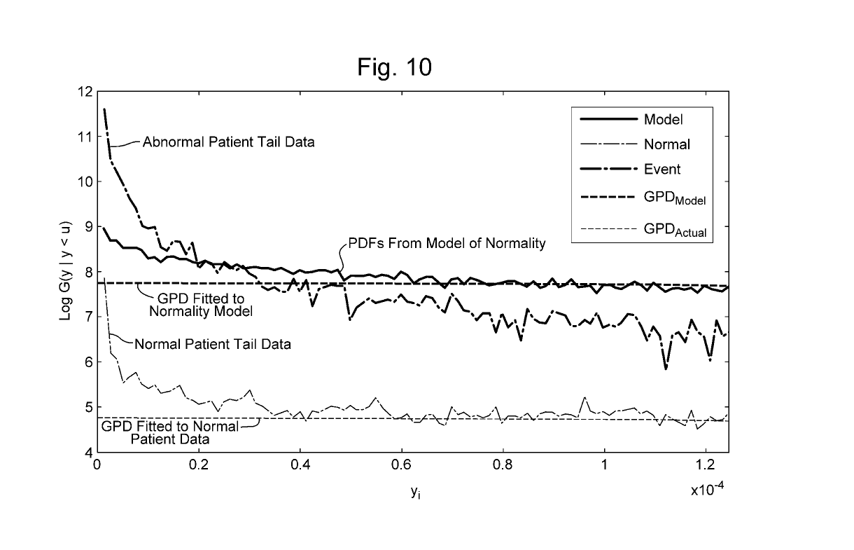

FIG. 10 illustrates the PDF values of tail data of patient vital signs data in normal and abnormal states, and also generated from the model of normality, together with the GPDs fitted to the normal patient data and the model of normality data.

An embodiment of the invention will now be explained in the form of a patient monitoring method (and corresponding apparatus) assuming that a statistical model of normality for that patient is available. How to create such a model will be described later with respect to FIG. 7.

Referring to FIG. 4 a first step in the method is to collect in step 40 the patient vital signs data which is typically 5 or 6 dimensional, each dimension corresponding to one of the measured parameters such as heart rate, breathing rate, oxygen saturation (SpO₂), temperature, systolic blood pressure and diastolic blood pressure.

In step 42 the data is subjected to filtering and pre-processing of conventional types such as median filtering and to account for sensor failure. Then in step 44 the data is windowed or buffered into an appropriate length depending on the frequency of measurement. Typically such vital signs measurements are made repeatedly at a frequency appropriate for each of the different parameters. Thus blood pressures may be measured once every 15 or 30 minutes, whereas heart rate or oxygen saturation are measured more frequently. Slowly varying or infrequently measured parameters can just be repeated from data point to data point until updated by a new measurement.

In step 46 the parameters are individually normalised, typically by subtracting them from a mean value (which can be derived from a training set of data or typical values) so that all of the parameters are defined over a similar dynamic range. These steps result in a set of multivariate data points x(HR, BR, SpO₂, T, BP_{sys}, BP_{dia}). In step 48 the data is transformed into the probability space by finding for each data point a probability density value y(x). This is achieved by reading the y value off a statistical model of normality 50, such as a pdf fitted to a training set of data points which are known to represent normal states of the system. Such a pdf (e.g. a mixture of Gaussians, e.g. a mixture of 400 Gaussians for human vital signs data) gives a y value for each x value.

FIG. 8a illustrates a 2-dimensional bimodal distribution fitted to a set of example data points, visualised as a surface fitted to the data points. The two axes in the horizontal plane as illustrated represent the component parameters of x (i.e. the measurements) with frequency of occurrence and thus y value plotted vertically. The surface representing the pdf is fitted to the frequency of occurrence values. Then the pdf value of any given data point x is they value of the surface for that x.

FIG. 8b shows a plot of the distribution of these PDF values y of the example data of FIG. 8a.

There are then two ways of distinguishing abnormal from normal states. The first way, illustrated by step 49 is to compare the y value of the datapoint to a threshold w previously set in a training process illustrated in FIG. 6. The second way is illustrated in FIG. 5.

As shown in FIG. 5 in step 52 the tail of the distribution is defined in probability space by setting a threshold u (the vertical dotted line in FIG. 8b) above which are the higher probability values in the distribution and below which the tail or low probability values. The threshold u can be set by normal statistical techniques, for example it may correspond to the 95^{th}, 98^{th}, 99^{th} percentile or may be heuristically based on experience or on training data. The valid setting of such thresholds is well-understood, usually involving an initial estimate which can be validated on a validation set of data.

In step 54 a Generalised Pareto Distribution (GPD) is fitted to these tail pdf values only by one of the well-known fitting techniques. The probability space y of these tail pdfs has compact support, i.e. values from 0 to some maximum yₘₐₓ, and therefore the shape parameter of the GPD ξ≦−0.5 and the location parameter v=0. Thus the 3-parameter [v, β, ξ] estimation problem is reduced to a two-parameter estimation for ξ and β. These can be estimated using a maximum likelihood (ML) estimation method which returns values for β and ξ. FIG. 9b shows a quantile-quantile (QQ) plot showing the fit of the GPD to the example tail observations illustrated in FIG. 8. It can be seen that the GPD closely describes the tail observations. FIG. 9b shows the tail likelihoods φ transformed back into the original bivariate data space of X using φ(y)=1−1n(y) for the purposes of visualisation.

FIG. 10 illustrates the distribution of tail pdfs for both normal patient vital signs data (lower solid plot labelled “Normal patient tail data”) and abnormal patient vital signs data (the solid plot which starts at a value on the ordinate (y-axis) between values 11 and 12 and is labelled “Abnormal patient tail data”). It can be seen in FIG. 10 that the distribution of tail pdf values from the patient in an abnormal state is quite separate from the distribution of tail pdf values for normal data. The lowest dotted line is a GPD fitted to the normal patient tail data (the dotted line just below an ordinate value of 5). It can be seen that there is a large separation between the abnormal tail pdf values and the GPD fitted to the normal tail pdfs. This allows distinguishing between normal and abnormal data by simply comparing the distribution of the tail pdfs of the collected data, or a GPD fitted to that distribution, to a target normal GPD such as the lower dotted line in FIG. 10. FIG. 5 illustrates this process in which in step 56 a comparison between the distribution of the tail pdf values (y values) of the collected data, or a GPD fitted to that distribution, is compared to a target GPD corresponding to normal data and in step 58 an alarm is considered, for example depending on whether the difference between the two exceeds a predefined threshold. There are several well-known ways of comparing distributions such as finding the Kullback-Leibler (KL) divergence or by the Kolmogorov-Smirnov (KS) test.

By way of comparison FIG. 10 also shows a distribution of tail pdf values synthetically generated from the model of normality (the solid plot starting from an ordinate value just below 9 and labelled “PDFs from model of normality”). Thus values of x are randomly generated and their y values read off the pdf model of normality, then those which are below the threshold u are retained and their distribution is plotted in FIG. 10. A GPD fitted to it is also shown (the dotted line just below value 8). This distribution is, as seen, close to the distribution of tail pdfs from abnormal data, but it was generated from the model of normality—not from abnormal data. It is quite different from the actual distribution of tail pdfs from a normal patient (the bottom lines in FIG. 10) showing clearly the fact that the model of normality does not accurately model the tail data.

FIG. 6 illustrates the training process for obtaining the second threshold w for step 49. This is based on calculating an extreme value distribution of the GPD fitted to the tail pdf values y of a normal (training) data set and basing an alarm threshold on this extreme value distribution.

Thus in step 60, having fitted a GPD to the tail data of a normal data set (e.g as shown below with reference to FIG. 7), a large number (e.g. one million) sets of m (for example 100) points are generated from the fitted GPD (effectively synthetic pdf values y) and within each set of m points in step 61 the extremum is found, i,e., the lowest PDF value yₘᵢₙ. In step 62 a distribution of these minimum pdf values can be plotted and in step 63 an appropriate extreme value distribution (e.g. a Weibull distribution) is fitted to this distribution.

In step 64 the threshold w is defined as that y value which separates a desired portion, e.g. the highest 99%, of the probability mass from the 1% lower probability remainder. That is to say the integral (area under the curve) from the highest probability end of the distribution to the threshold w is 99% of the total. This can be understood as meaning that a pdf value less than w corresponds to a less than 1% chance that this is an extremum from a system in a normal (but extremal) state.

In the description above in step 48 it was necessary to compare the data points x to a model of normality to find probability density values, in step 56 a target GPD from normal data was required, and in step 60 it was necessary to generate tail PDFs from a normal data set. FIG. 7 illustrates how such a model of normality can be created.

Firstly, in step 80, a training data set is obtained containing data representative of known normal system states. For example in a medical context this can be patient vital signs reading from a patient or patients determined by a doctor to be in a normal condition. In steps 82, 84 and 86 the training data is subjected to the same filtering and pre-processing, windowing/buffering and normalisation steps as steps 42-46. Then in step 88 a statistical model of normality is constructed, for example by fitting an analytic probability density function to the distribution of the data. This model is used for reading-off pdf values for datapoints x in step 48. In step 90 the training data is transformed into probability space by finding the pdf value for each of the training data points and then in step 92 a threshold u is obtained which defines the tail pdf values. As in step 52 this threshold u can be based on known thresholds for distinguishing normal and abnormal data from the type of system being monitored. In step 94 a GPD is fitted to the pdf values of the tail data only. This fitted GPD forms the target GPD to which newly collected data is compared in step 56 of the monitoring method. The GPD from step 94 can also be used in step 60 to generate the synthetic pdf values for calculation of the EVD of tail pdf values for normal data.

1. A method of system monitoring to automatically detect abnormal states of a system, the method comprising the steps of:
(a) repeatedly measuring a plurality of system parameters to produce multi-parameter data points each representing the state of the system at a particular time;
(b) comparing each data point to a statistical model giving the probability density function of the normal states of the system to obtain a probability density function value for each data point; and
(d) determining whether or not the system state is normal by comparing the obtained probability density function values to a threshold based on a distribution function fitted to those probability density function values of a set of data points known to represent low probability normal states of the system.

2. A method according to claim 1 wherein the step (d) of determining whether or not the system state is normal comprises comparing the distribution of the obtained probability density function values to the fitted distribution function.

3. A method according to claim 1 wherein the step (d) of determining whether or not the system state is normal comprises comparing a distribution function fitted to the obtained probability density function values with the distribution function fitted to those probability density function values of a set of data points known to represent low probability normal states of the system.

4. A method according to claim 3 wherein the set of data points known to represent low probability normal states of the system are selected from a training data set of measurements on the system in a normal state as points which correspond to a probability density function value lower than a first predetermined threshold.

5. A method according to claim 1 wherein the step (d) of determining whether or not the system state is normal comprises comparing the pdf value of the datapoint to a threshold calculated by: fitting a distribution function to the pdf values of a set of data points known to represent low probability normal states of the system, then calculating an extreme value distribution of the fitted distribution function, and setting the threshold on the extreme value distribution as that value which separates a selected proportion of the higher probability mass from the lower probability remainder in the extreme value distribution.

6. A method according to claim 5 wherein the extreme value distribution is calculated by generating a plurality of sets of values from the fitted distribution function, selecting the extremum of each of said sets and fitting an analytic extreme value distribution to the selected extrema.

7. A method according to claim 6 wherein the analytic extreme value distribution is the Weibull distribution.

8. A method according to claim 1 wherein the distribution function is the Generalised Pareto Distribution.

9. A method according to claim 1 wherein the statistical model is multimodal.

10. A method according to claim 1 wherein the statistical model is multivariate, each variable of the statistical model corresponding to one parameter of said multi-parameter data points, each parameter being a measurement of an output of a sensor on the system.

11. A system monitor for monitoring the state of a system in accordance with the method of claim 1, the monitor storing said statistical model and being adapted to perform said repeated measurements of the state of the system to execute said method to classify the system state as normal or abnormal.

12. A system monitor according to claim 11 adapted to acquire measurements of said system state continually and to execute said method on a rolling window of m successive data points.

13. A system monitor according to claim 11 further adapted to store measurements of the system state classified as normal for use in retraining the statistical model.

14. A patient monitor comprising a system monitor according to claim 11 wherein said system is a human patient and said measurements of system parameters comprise measurements of at least two of: heart rate, breathing rate, oxygen saturation, body temperature, systolic blood pressure and diastolic blood pressure.
